(19) United States
(12) Patent Application Publication
(10) Pub. No.: US 2026/0148911 A1
(43) Pub. Date: May 28, 2026

(54) KEYSWITCH STRUCTURE AND KEYBOARD

(71) Applicant: DARFON ELECTRONICS CORP., Taoyuan City (TW)

(72) Inventors: Yu-Chun Hsieh, Taoyuan City (TW); Chen Yang, Taoyuan City (TW); Chih-Hung Chien, Taoyuan City (TW); Shao-Lun Hsiao, Taoyuan City (TW)

(73) Assignee: DARFON ELECTRONICS CORP., Taoyuan City (TW)

(21) Appl. No.: 19/392,023

(22) Filed: Nov. 17, 2025

Related U.S. Application Data
(60) Provisional application No. 63/725,689, filed on Nov. 27, 2024.

(30) Foreign Application Priority Data
Jun. 27, 2025 (TW) 114124328

(51) Int. Cl. H01H 13/84; H01H 13/04; H01H 13/10; H01H 13/14; H01H 13/52; H01H 13/70

(52) U.S. Cl. CPC H01H 13/84; H01H 13/04; H01H 13/10; H01H 13/14; H01H 13/52; H01H 13/7013

(57) ABSTRACT

A keyswitch structure includes a base, an upper casing, and a keycap. The base includes a lower casing and an elastic dome with a hole disposed above the lower casing. The upper casing is fixedly disposed above the base and has an opening. The keycap is detachably connected to the upper casing and has a keycap body and an impact post. The keycap body slidably passes through the opening. The impact post protrudes from the keycap body toward the base and extends into the hole. When the keycap is pressed toward to the upper casing, the key cap squeezes the elastic dome, and the impact post impacts the base to generate a sound. A keyboard includes a plurality of the keyswitch structures. The upper covers of the key structures are formed as a single component, and the lower covers of the key structures are formed as a single component.

### CROSS REFERENCE TO RELATED APPLICATIONS

This application claims the benefit of U.S. Provisional Application No. 63/725,689, filed on Nov. 27, 2024. The content of the application is incorporated herein by reference.

### BACKGROUND OF THE INVENTION

### 1. Field of the Invention

The present invention relates to a keyswitch structure and a keyboard, and more particularly to a keyswitch structure and a keyboard capable of generating a press sound.

### 2. Description of the Prior Art

Mechanical keys have multiple movable components. During the movement of the mechanical key, such as when a user presses the keycap, some components may collide with each other to produce a sound, and the components involved in producing the sound are not necessarily the same each time. Although this sound provides auditory feedback to the user, it is not designed for this purpose and is unstable; it is essentially a type of noise.

### SUMMARY OF THE INVENTION

In view of the problems in the prior art, an objective of the invention is to provide a keyswitch structure, which has a downward-protruding impact post on its keycap that impacts a base of the keyswitch structure to generate a stable sound when the keycap is pressed.

A keyswitch structure of an embodiment according to the invention includes a base, an upper casing, and a keycap. The base includes a lower casing and an elastic dome. The elastic dome is disposed above the lower casing and has a hole. The upper casing is fixedly disposed above the base and has an opening. The keycap is detachably connected to the upper casing and has a keycap body and an impact post. The keycap body slidably passes through the opening. The impact post protrudes from the keycap body toward the base and extends into the hole. Therein, when the keycap is pressed toward the upper casing, the keycap squeezes the elastic dome, and the impact post impacts the base to generate a sound. Therefore, the mechanism that generates sound (by the impact post impacting the base) is designed to generate a stable sound. Users can receive stable auditory feedback when pressing the keycap.

Another objective of the invention is to provide a keyboard, which includes a plurality of keyswitch structures. Each keyswitch structure includes a base, an upper casing, and a keycap. The base includes a lower casing and an elastic dome. The elastic dome is disposed above the lower casing and has a hole. The upper casing is fixedly disposed above the base and has an opening. The keycap is detachably connected to the upper casing and has a keycap body and an impact post. The keycap body slidably passes through the opening. The impact post protrudes from the keycap body toward the base and extends into the hole. Therein, the plurality of upper casings of the plurality of keyswitch structures are formed as a single component, and the plurality of lower casings of the plurality of keyswitch structures are formed as a single component. When the keycap is pressed toward the upper casing, the keycap squeezes the elastic dome, and the impact post impacts the base to generate a sound. Similarly, the mechanism that generates sound (by the impact post impacting the base) is designed to generate a stable sound. Users can receive stable auditory feedback when pressing the keycap.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a keyswitch structure according to a first embodiment.

FIG. 2 is an exploded view of the keyswitch structure in FIG. 1.

FIG. 3 is a sectional view of the keyswitch structure in FIG. 1 along the line X-X.

FIG. 4 is a sectional view of the keyswitch structure in FIG. 3 when in a pressed state.

FIG. 5 is an exploded view of a variation of the keycap.

FIG. 6 is a sectional view of a keyswitch structure according to a second embodiment.

FIG. 7 is a sectional view of a variation of the keyswitch structure in FIG. 6.

FIG. 8 is a sectional view of the keyswitch structure in FIG. 7 when in a pressed state.

FIG. 9 is a sectional view of a keyswitch structure according to a third embodiment.

FIG. 10 is a sectional view of a variation of the keyswitch structure in FIG. 9.

FIG. 11 is a sectional view of a keyswitch structure according to a fourth embodiment.

FIG. 12 is a sectional view of the keyswitch structure in FIG. 11 when in a pressed state.

FIG. 13 is a sectional view of a keyswitch structure according to a fifth embodiment.

FIG. 14 is a sectional view of the keyswitch structure in FIG. 13 when in a pressed state.

FIG. 15 is a schematic diagram illustrating a keyboard according to a sixth embodiment.

FIG. 16 is an exploded view of the keyboard in FIG. 15.

FIG. 17 is a sectional view of the keyboard in FIG. 15 along the line Y-Y.

### DETAILED DESCRIPTION

Directional terms mentioned in the following embodiments, such as up, down, left, right, front or back, etc., are only for reference to the directions in the attached drawings. The prefixes of component names, such as first, second, . . . , etc., are only used to distinguish components and facilitate description, and do not impose other restrictions on the components themselves; furthermore, components with the same prefix in various embodiments do not necessarily correspond. The correspondence of components in each embodiment should still depend on the specific structure described in each embodiment.

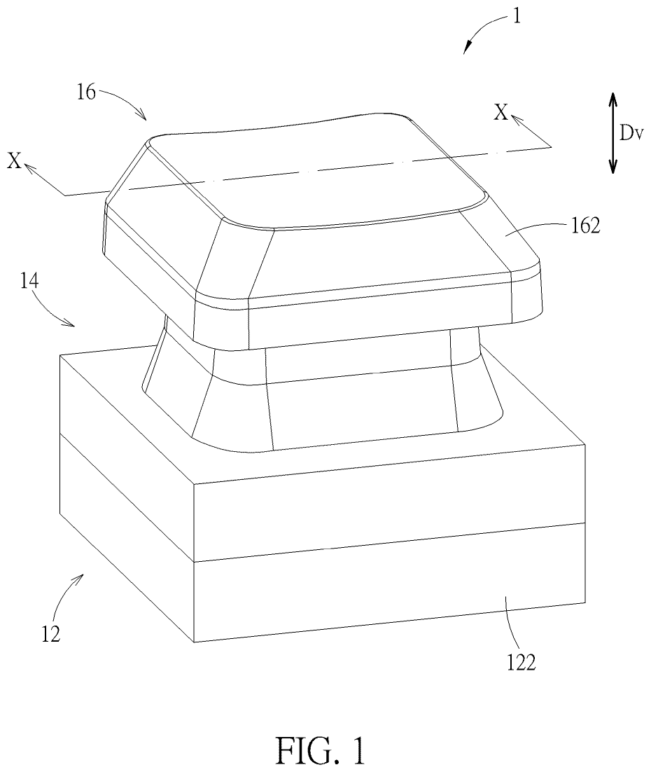

Please refer to FIG. 1 to FIG. 3. A keyswitch structure 1 according to a first embodiment includes a base 12, an upper casing 14, and a keycap 16. The base 12 includes a lower casing 122, an elastic dome 124, and a switch circuit board 126. The switch circuit board 126 is stacked on the lower casing 122. The elastic dome 124 is disposed above the lower casing 122 (i.e., stacked on the switch circuit board 126) and has a hole 124a. The upper casing 14 is fixedly disposed above the base 12; e.g., the upper casing 14 is directly and fixedly connected to the lower casing 122 around the upper casing 14 (e.g., by screws, by a snap-fit structure, etc.). The upper casing 14 has an opening 142, which passes through the upper casing 14 in a vertical direction Dv and aligns with the hole 124a of the elastic dome 124. The keycap 16 is detachably connected to the upper casing 14. Therein, the keycap 16 has a keycap body 162 and an impact post 164. The impact post 164 protrudes from the keycap body 162 toward the base 12. The keycap body 162 has a guiding pillar 162a. The opening 142 of the upper casing 14 structurally forms a sliding slot. The guiding pillar 162a matches the opening 142 in profile. The keycap body 162 is slidably connected to the sliding slot via the guiding pillar 162a so as to slide through the opening 142, allowing the keycap 16 to move up and down relative to the upper casing 14 (or move parallel to the vertical direction Dv). Two limitation hooks 162b are provided on opposite sides of the guiding pillar 162a. The two limitation hooks 162b can hook a lower edge of the opening 142 to prevent the keycap 16 from detaching from the upper casing 14. The impact post 164 protrudes from the keycap body 162 toward the base 12 and extends into the hole 124a of the elastic dome 124. The elastic dome 124 also supports the keycap 16 to provide a return force for the keycap 16 to move upwards.

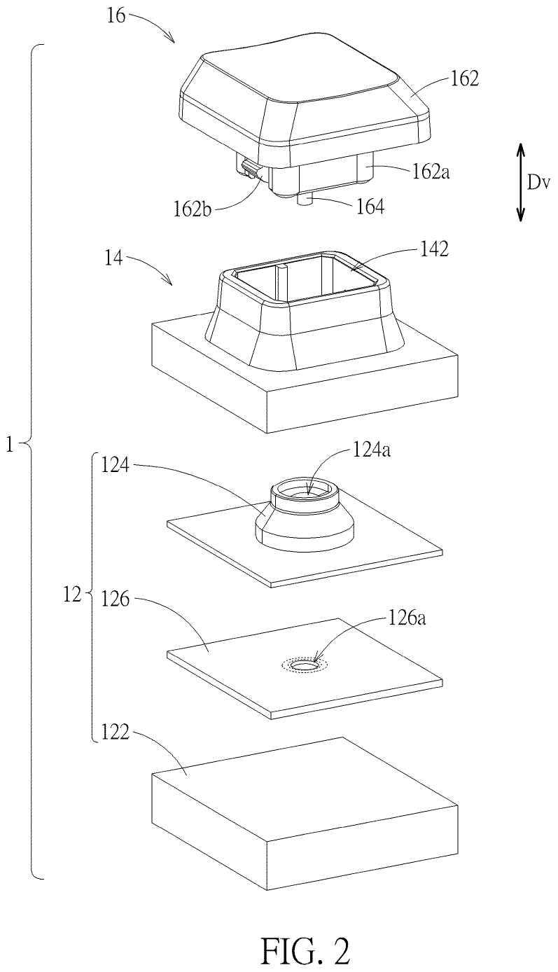

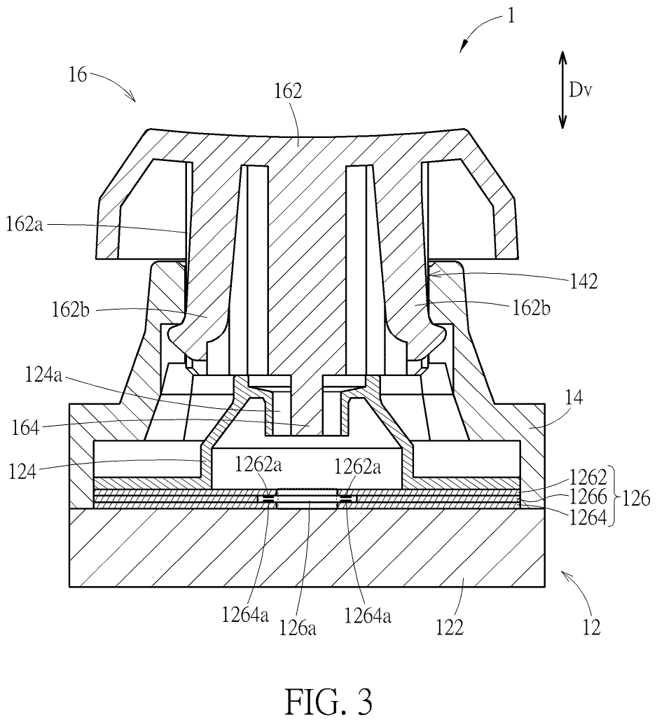

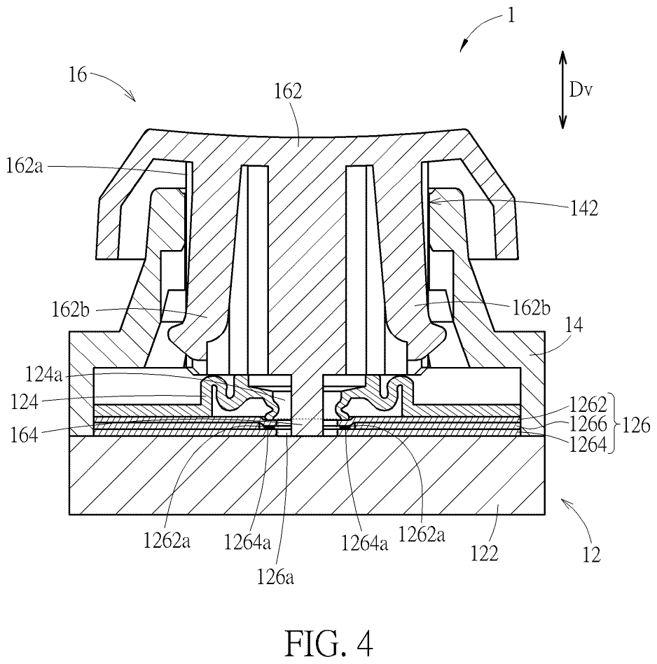

Please refer to FIG. 3 and FIG. 4. The keyswitch structure 1 in FIG. 3 is in an unpressed state; the keyswitch structure 1 in FIG. 4 is in a pressed state. When the keycap 16 is pressed toward the upper casing 14, the keycap 16 compresses the elastic dome 124 (causing elastic deformation of the elastic dome 124), and the impact post 164 impacts the base 12 to generate a sound. Furthermore, in the first embodiment, the switch circuit board 126 has a hole 126a (indicated by a dotted block in FIG. 3 and FIG. 4). The impact post 164 passes through the hole 124a of the elastic dome 124 and the hole 126a of the switch circuit board 126 and impacts the lower casing 122 to generate the sound. Moreover, the switch circuit board 126 is a layered structure (e.g., but not limited to, a membrane; in FIG. 2, it is represented as a single board for drawing simplification), which includes an upper substrate 1262, a lower substrate 1264, and a spacer layer 1266. Circuit lines are provided on both the upper substrate 1262 and the lower substrate 1264. The spacer layer 1266 is sandwiched between the upper substrate 1262 and the lower substrate 1264 to prevent accidental direct contact between the circuit lines on the upper substrate 1262 and the lower substrate 1264. The hole 126a of the switch circuit board 126 (indicated by a dotted block in FIG. 3 and FIG. 4) passes through the upper substrate 1262, the lower substrate 1264, and the spacer layer 1266. The circuit lines on the upper substrate 1262 form an annular switch contact 1262a. The circuit lines on the lower substrate 1264 form an annular switch contact 1264a. The two annular switch contacts 1262a and 1264a (indicated by a single dashed ring in FIG. 2) are arranged opposite each other and surround the hole 126a. When the keycap 16 is pressed toward the upper casing 14, the keycap 16 compresses the elastic dome 124 so that the two annual switch contacts 1262a and 1264a make direct contact, thereby triggering the two annual switch contacts 1262a and 1264a. When the keycap 16 is no longer pressed, the elastically deformed elastic dome 124 returns to its original shape and pushes the keycap 16 back to its original position.

Furthermore, in the first embodiment, the hole 124a of the elastic dome 124 has a stabilizing effect on the keycap 16, which reduces the wobble of the keycap 16 and in addition to improving the feel, also reduces noise caused by the wobble of the keycap 16. Moreover, the position at which the keycap 16 impacts the lower casing 122 through the impact post 164 is a sound-emitting point and is also the bottom dead center of the movement stroke of the keycap 16. The bottom dead center of the movement stroke of the keycap 16 that is determined by the lower casing 122 (e.g., molded as a rigid plastic part) is more stable than the bottom dead center of the movement stroke of the keycap 16 that is determined by a softer material or structure, such as an elastic dome or a membrane.

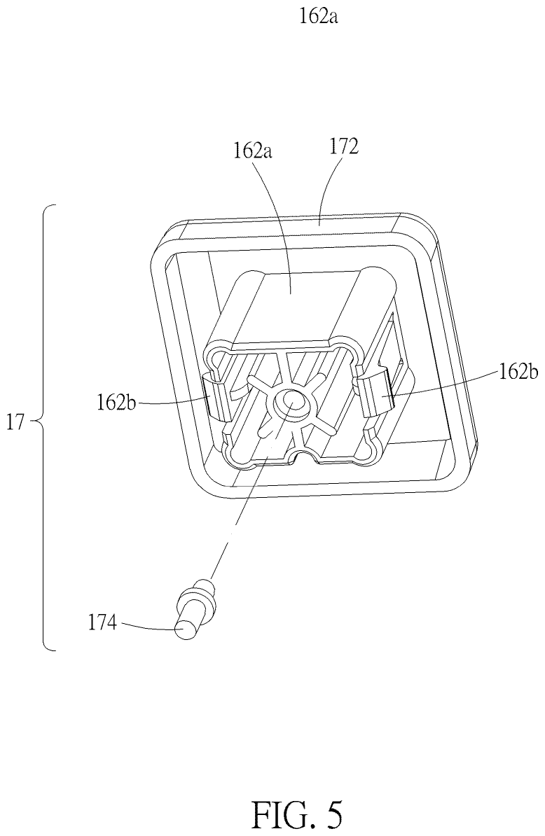

In addition, in practice, the sound generated by the impact post 164 impacting the base 12 can be modified by designing the contact between the impact post 164 and the base 12 (including the portion of the base 12 which the impact post 164 impacts, and the difference between the portion and the impact post 164 in terms of materials, structure, etc.). In the first embodiment, the keycap 16 is a single piece (e.g., a plastic injection molded part); the lower casing 122 is a plastic part. However, it is not limited thereto in practice. For example, in the keycap 17 shown by FIG. 5, the keycap body 172 and the impact post 174 are designed to be combined into a component. The impact post 174 is detachably inserted into a hole of the keycap body 172 so that the impact post 174 is detachably and fixedly connected to the keycap body 172, thereby forming the keycap 17 that functions the same as the keycap 16 in the first embodiment. In this embodiment, the keycap body 172 and impact post 174 can be made of different materials. For example, the keycap body 172 is still a plastic injection molded part, while the impact post 174 is a metal part. In this instance, users can replace different impact posts 174 (e.g., with different materials, different impact point structures, etc.) to change the sound generated by the impact post 174 impacting the base 12. In addition, even in the keyswitch structure 1, users still can change the sound by replacing different keycaps 16 (e.g., with different materials, different impact point structures, etc.). Furthermore, in practice, the keycap 16 can be formed by an insertion molding method, allowing the keycap body 162 and the impact post 164 to be made of different materials.

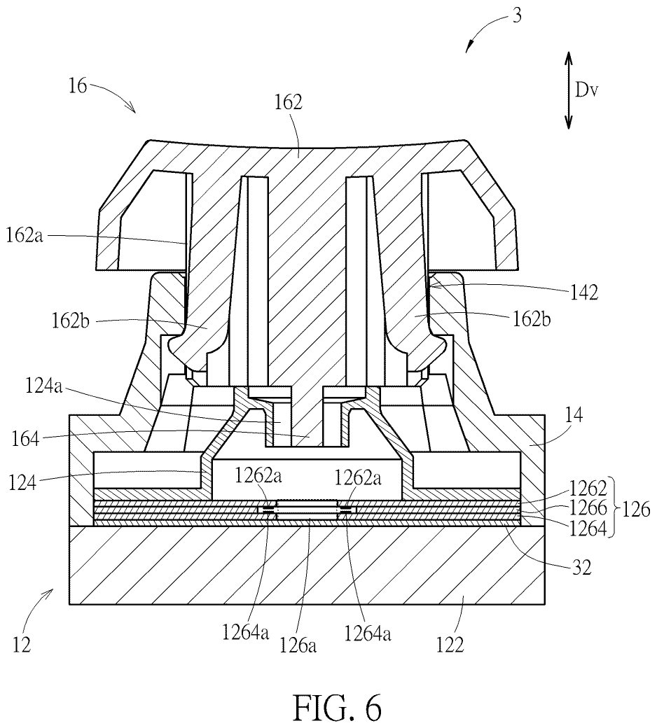

Please refer to FIG. 6, which is a sectional view of a keyswitch structure 3 according to a second embodiment. The position of the cutting plane is the same as that of the keyswitch structure 1. The keyswitch structure 3 is structurally similar to the keyswitch structure 1, so the keyswitch structure 3 uses the same component symbols as the keyswitch structure 1. For other descriptions about the keyswitch structure 3, please refer directly to the relevant descriptions of the same named components in the keyswitch structure 1, which will not be described in addition. A main difference between the keyswitch structure 3 and the keyswitch structure 1 is that the keyswitch structure 3 further includes a thin film 32, which is stacked on the lower casing 122, and the switch circuit board 126 is then stacked on the thin film 32. When the keycap 16 is pressed, the impact post 164 passes through the hole 124a of the elastic dome 124 and the hole 126a of the switch circuit board 126 and impacts the thin film 32 to generate a sound. The thin film 32 is made of a different material than the lower casing 122, for example, making the thin film 32 softer than the lower casing 122. The thickness of the thin film 32 can be determined through actual testing based on a desired sound timbre, which will not be described further.

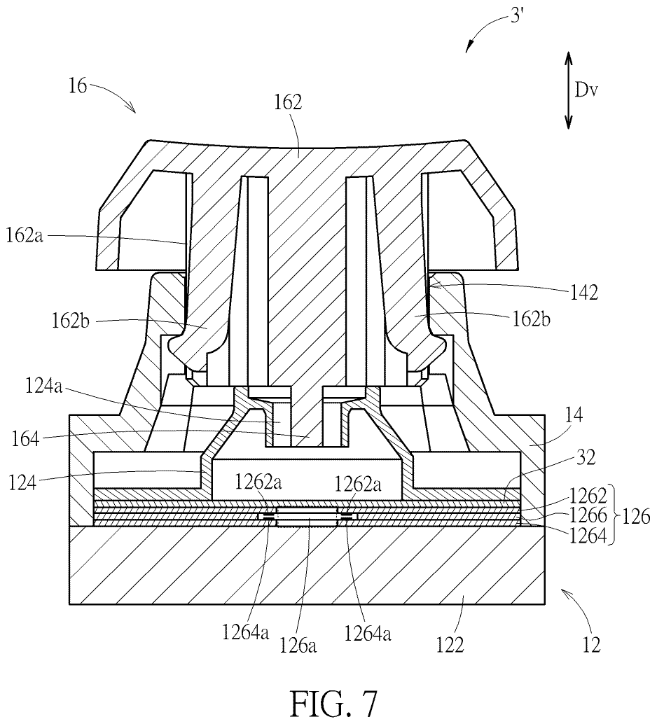

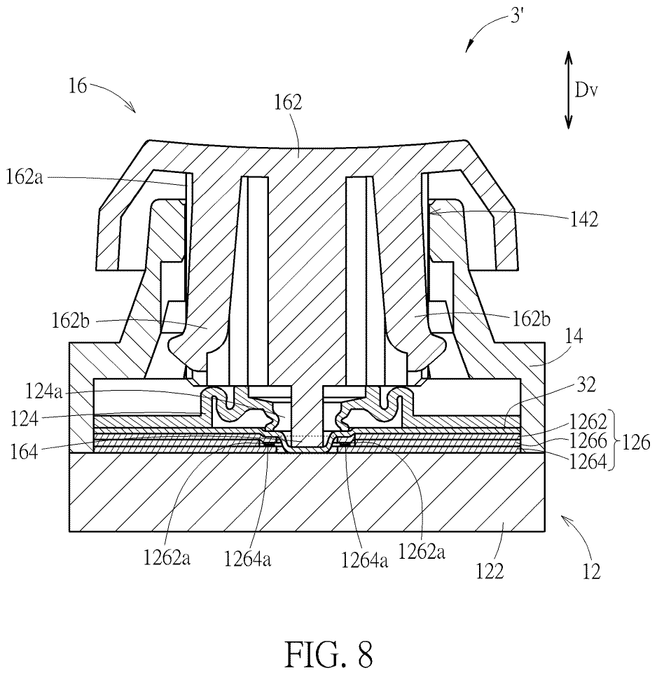

In the keyswitch structure 3, the thin film 32 is sandwiched between the lower casing 122 and the switch circuit board 126; however, it is not limited thereto in practice. For example, as shown by FIG. 7, in a keyswitch structure 3′ of this instance, the switch circuit board 126 is stacked on the lower casing 122, and the thin film 32 is then stacked on the switch circuit board 126. As shown by FIG. 8, when the keycap 16 is pressed, the impact post 164 passes through the hole 124a of the elastic dome 124 and presses against the thin film 32 to impact the lower casing 122 through the hole 126a of the switch circuit board 126 to generate the sound.

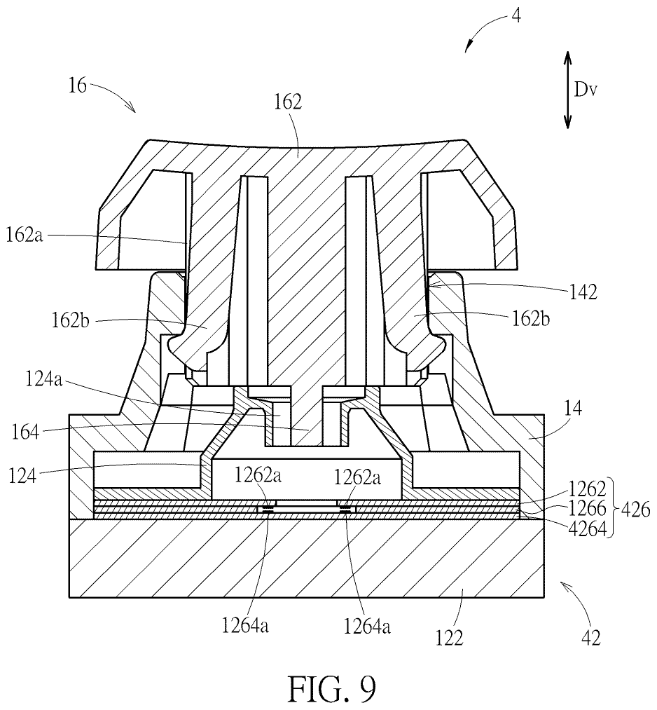

In the keyswitch structures 3 and 3′, the thin film 32 is a component other than the switch circuit board 126. However, it is not limited thereto in practice. For example, please refer to FIG. 9, which is a sectional view of a keyswitch structure 4 according to a third embodiment. The position of the cutting plane is the same as that of the keyswitch structure 1. The keyswitch structure 4 is structurally similar to the keyswitch structure 1, so the keyswitch structure 4 uses the same component symbols as the keyswitch structure 1. For other descriptions about the keyswitch structure 4, please refer directly to the relevant descriptions of the same named components in the keyswitch structure 1, which will not be described in addition. A main difference between the keyswitch structure 4 and the keyswitch structure 1 is that the switch circuit board 426 of the base 42 of the keyswitch structure 4 no longer forms a through hole corresponding to the impact post 164. In the switch circuit board 426, the upper substrate 1262 and the spacer layer 1266 are still provided with openings, while the lower substrate 4264 is not provided with openings. Thereby, when the keycap 16 is pressed, the impact post 164 passes through the hole 124a of the elastic dome 124 and impacts the lower substrate 4264 to generate a sound. On the other hand, the mechanism by which the keyswitch structure 4 generates sound is equivalent to the mechanism by which the keyswitch structure 3 generates sound. Therein, the keyswitch structure 4 is equivalent to the keyswitch structure 3 in which the thin film 32 is structurally integrated into the switch circuit board 126 (to form the structure of the switch circuit board 42 of the keyswitch structure 4). In practice, the lower substrate 4264 is made of a different material than the lower casing 122, making the lower substrate 4264 more flexible than the lower casing 122.

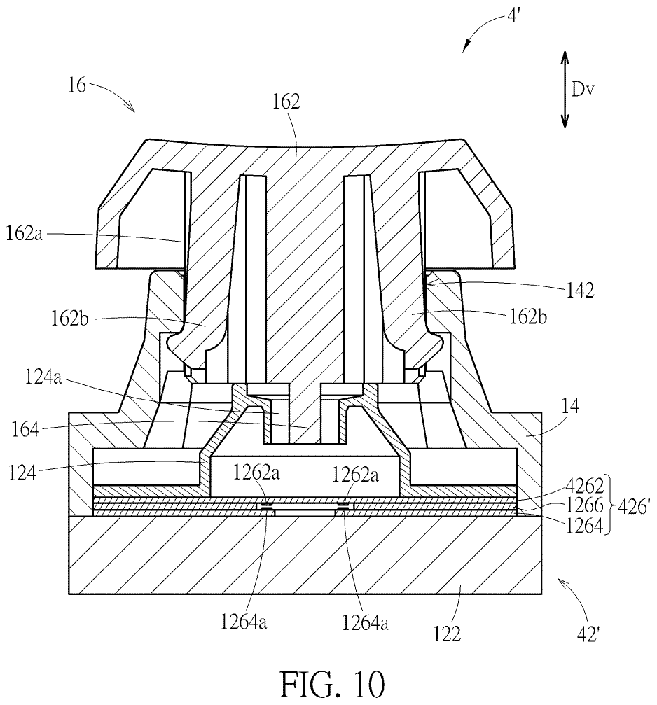

In the keyswitch structure 4, the impact post 164 impacts the lower substrate 4264 so as to generate a sound; however, it is not limited thereto in practice. For example, as shown by FIG. 10, in a keyswitch structure 4′ of this instance, the spacer layer 1266 and the lower substrate 1264 of the switch circuit board 426′ of the base 42′ are still provided with openings, while the upper substrate 4262 is not provided with openings. when the keycap 16 is pressed, the impact post 164 passes through the hole 124a of the elastic dome 124 and presses against the upper substrate 4262 to impact the lower casing 122 downward to generate the sound.

In the keyswitch structures 4 and 4′, it can be logically considered that the impact post 164 presses against the substrate (e.g., the upper substrate 4262, the lower substrate 4264) and impacts the lower casing 122 through the substrate to generate the sound. Furthermore, in practice, the substrate can include both the upper substrate 4262 and the lower substrate 4264 at the same time, which will not be described in addition.

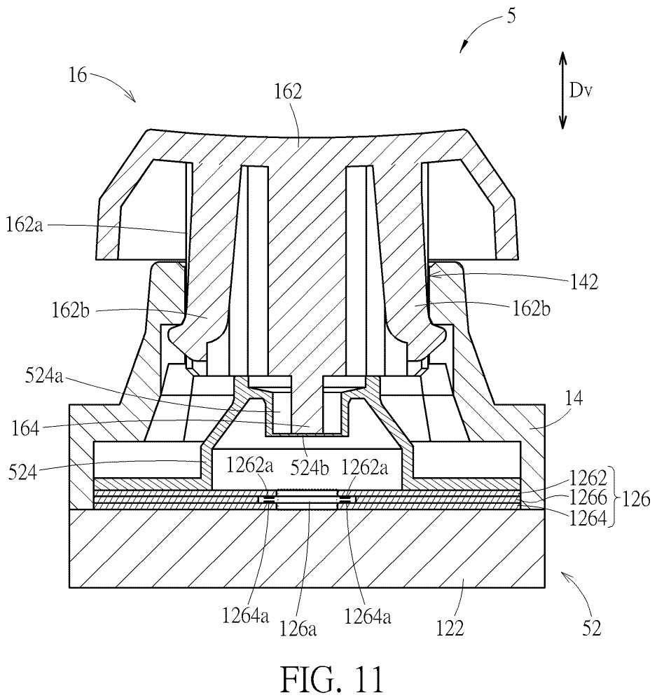

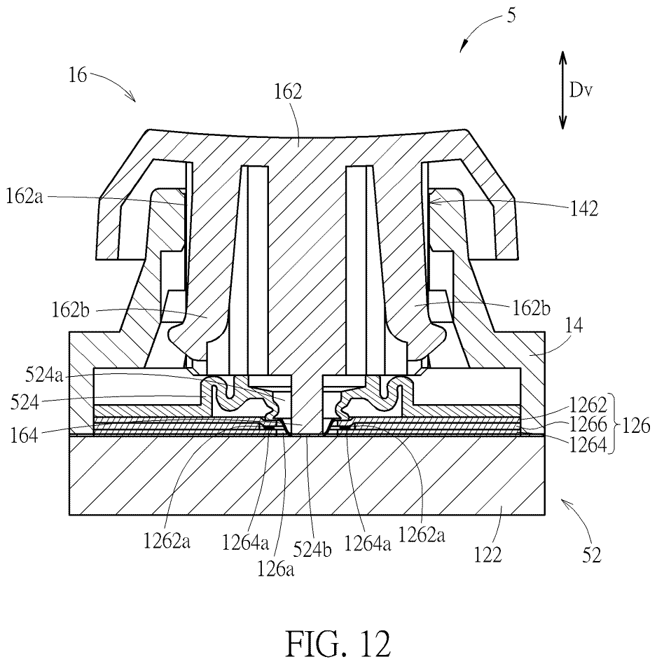

Please refer to FIG. 11, which is a sectional view of a keyswitch structure 5 according to a fourth embodiment. The position of the cutting plane is the same as that of the keyswitch structure 1. The keyswitch structure 5 is structurally similar to the keyswitch structure 1, so the keyswitch structure 5 uses the same component symbols as the keyswitch structure 1. For other descriptions about the keyswitch structure 5, please refer directly to the relevant descriptions of the same named components in the keyswitch structure 1, which will not be described in addition. A main difference between the keyswitch structure 5 and the keyswitch structure 1 is that the hole 524a of the elastic dome 524 of the base 52 of the keyswitch structure 5 is a blind hole, of which the bottom portion 524b is a thin film structure. As shown by FIG. 12, when the keycap 16 is pressed, the impact post 164 presses against the bottom portion 524b to impact the lower casing 122 through the hole 126a of the switch circuit board 126 to generate a sound. In practice, the elastic dome 524 can be made of rubber. The thickness of the bottom portion 524b can be determined through actual testing based on a desired sound timbre, which will not be described further.

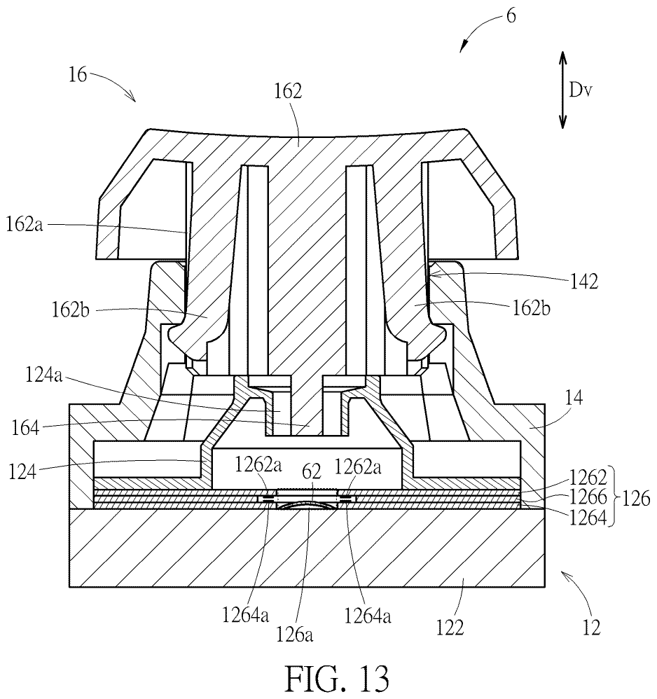

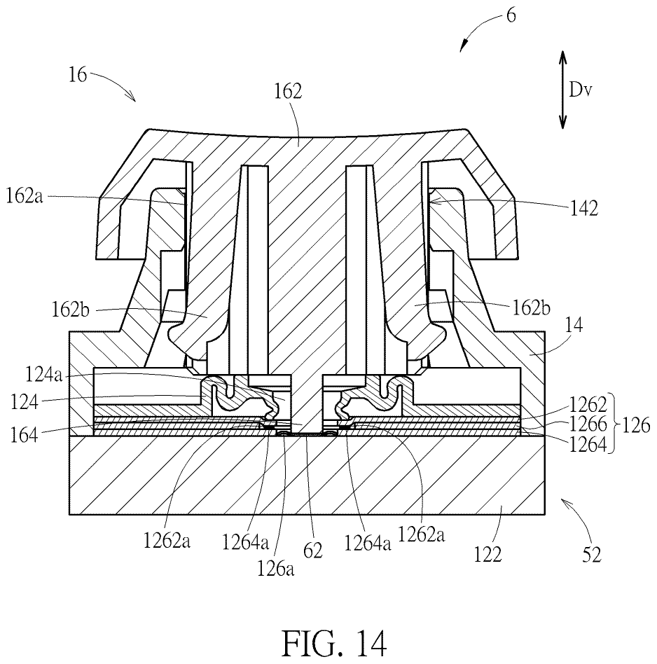

Please refer to FIG. 13, which is a sectional view of a keyswitch structure 6 according to a fifth embodiment. The position of the cutting plane is the same as that of the keyswitch structure 1. The keyswitch structure 6 is structurally similar to the keyswitch structure 1, so the keyswitch structure 6 uses the same component symbols as the keyswitch structure 1. For other descriptions about the keyswitch structure 6, please refer directly to the relevant descriptions of the same named components in the keyswitch structure 1, which will not be described in addition. A main difference between the keyswitch structure 6 and the keyswitch structure 1 is that the keyswitch structure 6 further includes an elastic shallow dish 62, which is disposed on the lower casing 122 and located in the hole 126a of the switch circuit board 126. The elastic shallow dish 62 and the lower casing 122 are made of different materials; for example, the elastic shallow dish 62 is a metal part. As shown by FIG. 14, when the keycap 16 is pressed, the impact post 164 passes through the hole 124a of the elastic dome 124 and presses against the elastic shallow dish 62 to impact the lower casing 122 to generate a sound.

In addition, the keycap 17 shown in FIG. 5 is also applicable to the keyswitch structures 3, 4, 5 and 6 and their variations, which will not be described further. Furthermore, if the structures of the keyswitch structures 1, 3, 4, 5 and 6 and their variations can be combined and implemented in the same keyswitch structure, this keyswitch structure can also be used as an example of a keyswitch structure that can generate a stable sound. For example, the keyswitch structure 5 and the keyswitch structure 6 are structurally combined into the same keyswitch structure, e.g., by replacing the elastic dome 124 of the keyswitch structure 6 with the elastic dome 524 of the keyswitch structure 5, or by disposing the elastic shallow dish 62 of the keyswitch structure 6 in the hole 126a of the switch circuit board 126 of the keyswitch structure 5.

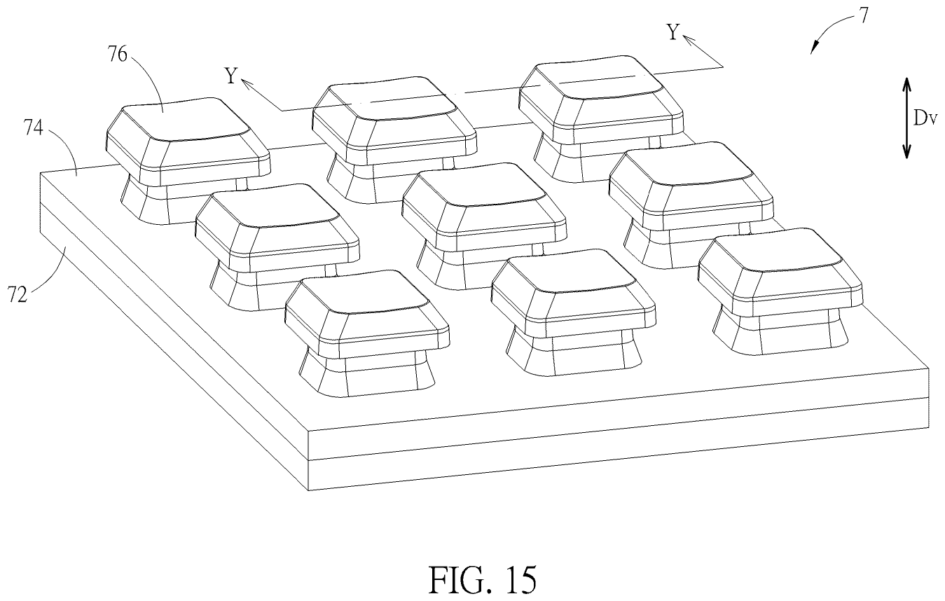

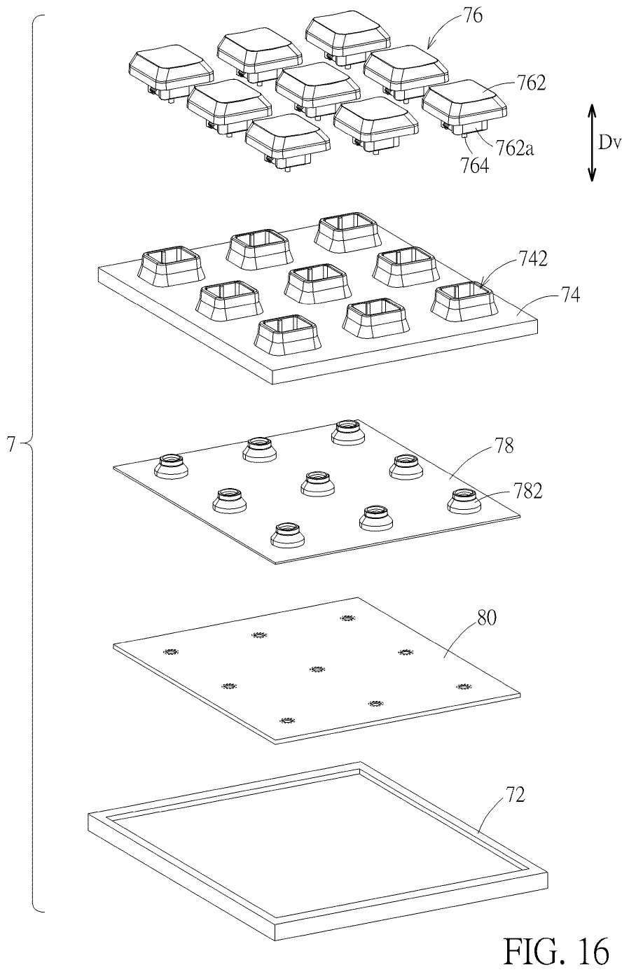

Please refer to FIG. 15 to FIG. 17. A keyboard 7 according to a sixth embodiment includes a lower housing part 72, an upper housing part 74, a plurality of keycaps 76, an elastic dome sheet 78, and a switch circuit board 80. The upper housing part 74 is joined to an upper side of the lower housing part 72. The upper housing part 74 and the lower housing part 72 jointly form an accommodating space 70. The upper housing part 74 has a plurality of openings 742. The switch circuit board 80 is stacked on the lower housing part 72. The switch circuit board 80 has a plurality of pairs of switch contacts (in FIG. 16, each pair of switch contacts is represented by a single circle filled with diagonal lines), and each pair of switch contacts corresponds to one opening 742. The elastic dome sheet 78 is disposed above the lower housing part 72 (or stacked on the switch circuit board 80). The elastic dome sheet 78 includes a plurality of elastic domes 782, each of which corresponds to one opening 742 and one pair of switch contacts. The plurality of keycaps 76 are disposed on the upper housing part 74 corresponding to the plurality of openings 742. Therein, each keycap 76 has a keycap body 762 and an impact post 764. The impact post 764 protrudes from the keycap body 762 toward the lower housing part 72. The keycap body 762 has a guiding pillar 762a. The guiding pillar 762a matches the opening 742 in profile. The keycap body 762 is slidably connected to the corresponding opening 742 through its guiding pillar 762a, so that the keycap 76 can move up and down relative to the upper housing part 74 (or move parallel to the vertical direction Dv).

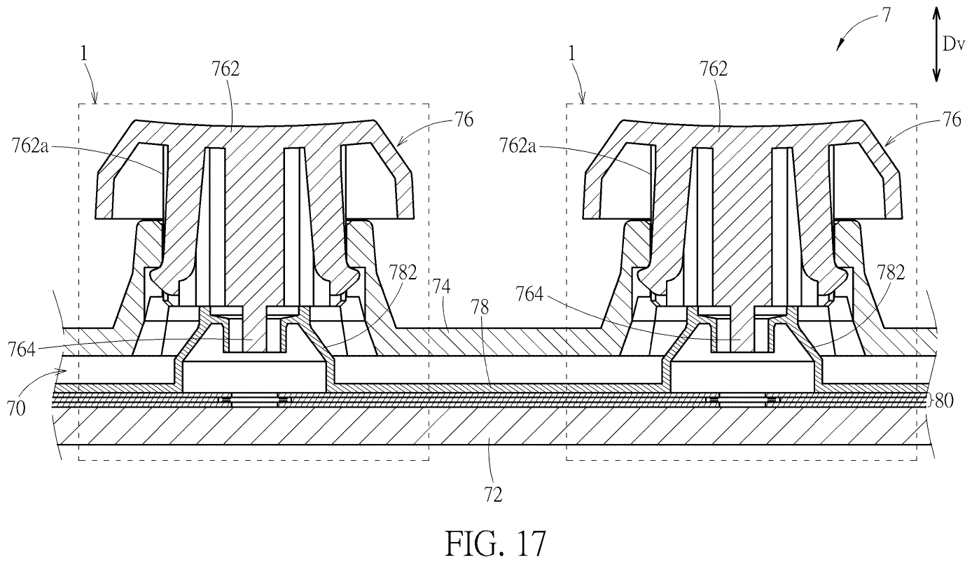

In the sixth embodiment, the keyboard 7 is structurally equivalent to a combination of a plurality of the keyswitch structures 1. As shown by FIG. 17, one keyswitch structure 1 is indicated by one dashed block. Therein, the lower casing 122 of the keyswitch structure 1 (also see FIG. 3, and the same applies below) is equivalent to the corresponding portion of the lower housing part 72. The upper casing 14 of the keyswitch structure 1 is equivalent to the corresponding portion of the upper housing part 74. The keycap 16 of the keyswitch structure 1 is equivalent to the corresponding portion of the corresponding keycap 76. The elastic dome 124 of the keyswitch structure 1 is equivalent to the corresponding portion of the corresponding elastic dome 782 (of the elastic dome sheet 78). The switch circuit board 126 of the keyswitch structure 1 is equivalent to the corresponding portion of the corresponding portion of the switch circuit board 80. For other descriptions about the keyswitch structures of the keyboard 7, please refer directly to the relevant descriptions of the keyswitch structure 1, which will not be described in addition. Therefore, in the keyboard 7, all of the upper casings 14 of the keyswitch structures 1 are formed into a single component (i.e., the upper housing part 74); all of the lower casing 122 of the keyswitch structures 1 are formed into a single component (i.e., the lower housing part 72); all of the elastic domes 124 of the keyswitch structures 1 are formed into a single component (i.e., the elastic dome sheet 78); all of the switch circuit boards 126 of the keyswitch structures 1 are formed into a single component (i.e., the switch circuit board 80). In addition, in principle, the keyswitch structures 1, 3, 4, 5 and 6 and their variations (including the structural combinations of the keyswitch structures mentioned above, such as the structural combination of the keyswitch structure 5 and the keyswitch structure 6) are applicable to the keyboard 7, which will not be described in addition. Moreover, the keyboard 7 is a nine-key keyboard; however, it is not limited thereto in practice. For example, the keyboard 7 can be structurally expanded into a computer keyboard, which will not be described in addition.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyswitch structure, comprising:
a base, the base comprising a lower casing and an elastic dome, the elastic dome being disposed above the lower casing and having a hole;
an upper casing, the upper casing being fixedly disposed above the base and having an opening; and
a keycap, the keycap being detachably connected to the upper casing and having a keycap body and an impact post, the keycap body slidably passing through the opening, the impact post protruding from the keycap body toward the base and extending into the hole;
wherein when the keycap is pressed toward the upper casing, the keycap squeezes the elastic dome, and the impact post impacts the base to generate a sound.

2. The keyswitch structure according to claim 1, wherein the impact post passes through the hole and impacts the lower casing to generate the sound.

3. The keyswitch structure according to claim 1, wherein the base comprises a switch circuit board stacked on the lower casing, the switch circuit board has a hole, and the impact post passes through the hole of the elastic dome and the hole of the switch circuit board and impacts the lower casing to generate the sound.

4. The keyswitch structure according to claim 3, wherein the switch circuit board comprises an annular switch contact surrounding the hole of the switch circuit board, and when the keycap is pressed toward the upper casing, the keycap squeezes the elastic dome to trigger the annular switch contact.

5. The keyswitch structure according to claim 1, wherein the base comprises a thin film stacked on the lower casing, the thin film is made of a different material than the lower casing, and the impact post passes through the hole and impacts the thin film to generate the sound.

6. The keyswitch structure according to claim 1, wherein the base comprises a switch circuit board and a thin film, the switch circuit board is stacked on the lower casing, the thin film is stacked on the switch circuit board, the thin film is made of a different material than the lower casing, the switch circuit board has a hole, and the impact post passes through the hole of the elastic dome and presses against the thin film to impact the lower casing through the hole of the switch circuit board to generate the sound.

7. The keyswitch structure according to claim 6, wherein the switch circuit board comprises an annual switch contact surrounding the hole of the switch circuit board, and when the keycap is pressed toward the upper casing, the keycap squeezes the elastic dome to trigger the annual switch contact.

8. The keyswitch structure according to claim 1, wherein the base comprises a switch circuit board stacked on the lower casing, the impact post passes through the hole of the elastic dome and presses against the switch circuit board to impact the lower casing to generate the sound.

9. The keyswitch structure according to claim 8, wherein the switch circuit board is a layered structure comprising a substrate, the impact post passes through the hole of the elastic dome and presses against the substrate to impact the lower casing through the substrate to generate the sound.

10. The keyswitch structure according to claim 1, wherein the hole of the elastic dome is a blind hole, the blind hole has a bottom portion, the bottom portion is a thin film structure, and the impact post presses against the bottom portion to impact the lower casing to generate the sound.

11. The keyswitch structure according to claim 10, wherein the base comprises a switch circuit board stacked on the lower casing, the switch circuit board has a hole, and the impact post presses against the bottom portion to impact the lower casing through the hole of the switch circuit board to generate the sound.

12. The keyswitch structure according to claim 11, wherein the switch circuit board comprises an annual switch contact surrounding the hole of the switch circuit board, and when the keycap is pressed toward the upper casing, the keycap squeezes the elastic dome to trigger the annual switch contact.

13. The keyswitch structure according to claim 1, wherein the base comprises an elastic shallow dish placed on the lower casing, the elastic shallow dish is made of a different material than the lower casing, and the impact post passes through the hole and presses against the elastic shallow dish to impact the upper casing to generate the sound.

14. The keyswitch structure according to claim 1, wherein the base comprises a switch circuit board and an elastic shallow dish, the switch circuit board is stacked on the lower casing, the switch circuit board has a hole, the he elastic shallow dish is disposed on the lower casing and located in the hole of the switch circuit board, the impact post passes through the hole of the elastic dome and presses against the elastic shallow dish to impact the upper casing through the elastic shallow dish to generate the sound.

15. The keyswitch structure according to claim 14, wherein the switch circuit board comprises an annual switch contact surrounding the hole of the switch circuit board, and when the keycap is pressed toward the upper casing, the keycap squeezes the elastic dome to trigger the annual switch contact.

16. The keyswitch structure according to claim 1, wherein the impact post is detachably and fixedly connected to the keycap body.

17. The keyswitch structure according to claim 1, wherein the upper casing is fixedly connected to the lower casing.

18. A keyboard, comprising:
a plurality of keyswitch structures, each keyswitch structure comprising:
a base, the base comprising a lower casing and an elastic dome, the elastic dome being disposed above the lower casing and having a hole;
an upper casing, the upper casing being fixedly disposed above the base and having an opening; and
a keycap, the keycap being detachably connected to the upper casing and having a keycap body and an impact post, the keycap body slidably passing through the opening, the impact post protruding from the keycap body toward the base and extending into the hole;
wherein the plurality of upper casings of the plurality of keyswitch structures are formed as a single component, and the plurality of lower casings of the plurality of keyswitch structures are formed as a single component;
wherein when the keycap is pressed toward the upper casing, the keycap squeezes the elastic dome, and the impact post impacts the base to generate a sound.

19. The keyboard according to claim 18, wherein the plurality of elastic domes of the plurality of keyswitch structure are formed as a single component.

20. The keyboard according to claim 18, wherein the impact post passes through the hole and impacts the lower casing to generate the sound.
